(19) United States
(12) Patent Application Publication
(10) Pub. No.: US 2017/0261235 A1
(43) Pub. Date: Sep. 14, 2017

(54) SYSTEM FOR COOLING AN ELECTRICAL COMPONENT OF A MACHINE

(71) Applicant: Electro-Motive Diesel, Inc., LaGrange, IL (US)

(72) Inventor: Joseph Randall Bushen, Crest Hill, IL (US)

(73) Assignee: Electro-Motive Diesel, Inc., LaGrange, IL (US)

(21) Appl. No.: 15/067,325

(22) Filed: Mar. 11, 2016

(51) Int. Cl. F25B 9/00; B61C 5/00; B61C 17/00; F17C 9/02

(52) U.S. Cl. CPC F25B 9/002; F17C 9/02; B61C 5/00; B61C 17/00; F17C 2221/033; F17C 2227/0339; F17C 2265/033; F17C 2270/0173

(57) ABSTRACT

A system for cooling at least one electrical component of a machine. The machine is powered by a liquefied natural gas (LNG). The system includes at least one blower and at least one heat exchanger. The at least one blower is arranged to direct an air flow towards the at least one electrical component. The at least one heat exchanger is arranged upstream of the at least one electrical component. The at least one heat exchanger is using LNG as the coolant for cooling the air flow being directed towards the at least one electrical component.

### TECHNICAL FIELD

The present disclosure relates generally to the field of locomotives. In particular, the present disclosure relates to a system for cooling components of a locomotive.

### BACKGROUND

Machines have several components that generate heat during their operation. The components may include braking grids, traction motors, alternators and auxiliary motors driving fan(s)/blower(s). If the heat generated by these components surpass their respective thermal limits, such components may malfunction or a complete breakdown/failure of the component may occur.

The heat generated can be regulated by either using components which generate less heat or by making heat dissipation more effective. The use of components generating less heat is both costlier and demanding as it requires regularly replacing/updating systems for any change in power requirement. In general, external cooling agents may be used to dissipate excess heat being generated in the component. The use of external cooling agents requires additional systems and thus power, which affects the overall efficiency of the machine. The additional systems increase the complexity of the machine, thereby making usage and maintenance an issue.

U.S. Patent Application No. 2014/0318503 discloses use of a system for the exchange of thermal energy from electrical locker of a locomotive to a flow of liquefied gas. The document discloses a heat exchanger configured into the electrical locker and drawing heat from it, a storage container cryogenically storing the liquefied gas and a cryogenic pump for receiving liquefied gas from the storage container and pumping it to a location for its vaporization using the heat from the heat exchanger.

### SUMMARY OF THE INVENTION

The present disclosure provides for a system for cooling at least one electrical component of a machine. The machine is powered by liquefied natural gas. The system includes at least one blower and at least one heat exchanger. The at least one blower is arranged to direct an air flow towards the at least one electrical component. The at least one heat exchanger is arranged upstream of the at least one electrical component. The at least one heat exchanger uses the liquefied natural gas as coolant for cooling the air flow being directed towards the at least one electrical component.

The present disclosure further provides for a machine. The machine includes at least one engine, at least one electrical component, at least one blower and at least one heat exchanger. The at least one engine is powered by liquefied natural gas. The at least one blower is arranged to direct an air flow towards the at least one electrical component. The at least one heat exchanger is arranged upstream of the at least one electrical component. The at least one heat exchanger uses the liquefied natural gas as coolant for cooling the air flow being directed towards the at least one electrical component.

In yet another aspect, a locomotive is disclosed. The locomotive includes at least one engine powered by liquefied natural gas, at least one container, at least one electrical component, at least one blower and at least one heat exchanger. The at least one container is to store the liquefied natural gas and configured to supply the liquefied natural gas to the at least one engine. The at least one electrical component is associated with an electric traction system of the locomotive. The at least one blower is arranged to direct an air flow towards the at least one electrical component. The at least one heat exchanger is arranged upstream of the at least one electrical component. The at least one heat exchanger uses the liquefied natural gas as coolant for cooling the air flow being directed towards the at least one electrical component.

### BRIEF DESCRIPTION OF THE DRAWINGS

FIG. 1 illustrates a side perspective view of a locomotive in accordance with an embodiment.

FIG. 2 illustrates an enlarged view of the locomotive in accordance with an embodiment.

FIG. 3 illustrates an enlarged view of a cooling system in accordance with an embodiment.

FIG. 4 illustrates an enlarged view of the cooling system in accordance with an embodiment.

FIG. 5 illustrates an enlarged view of the cooling system in accordance with an embodiment.

FIG. 6 illustrates an exploded view of the blower in accordance with an embodiment.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

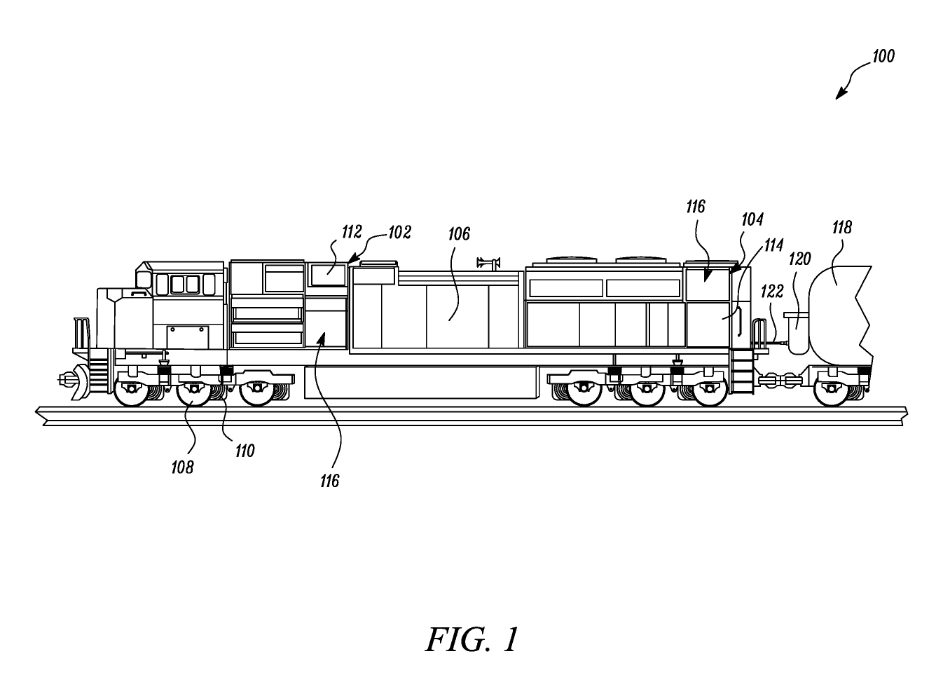

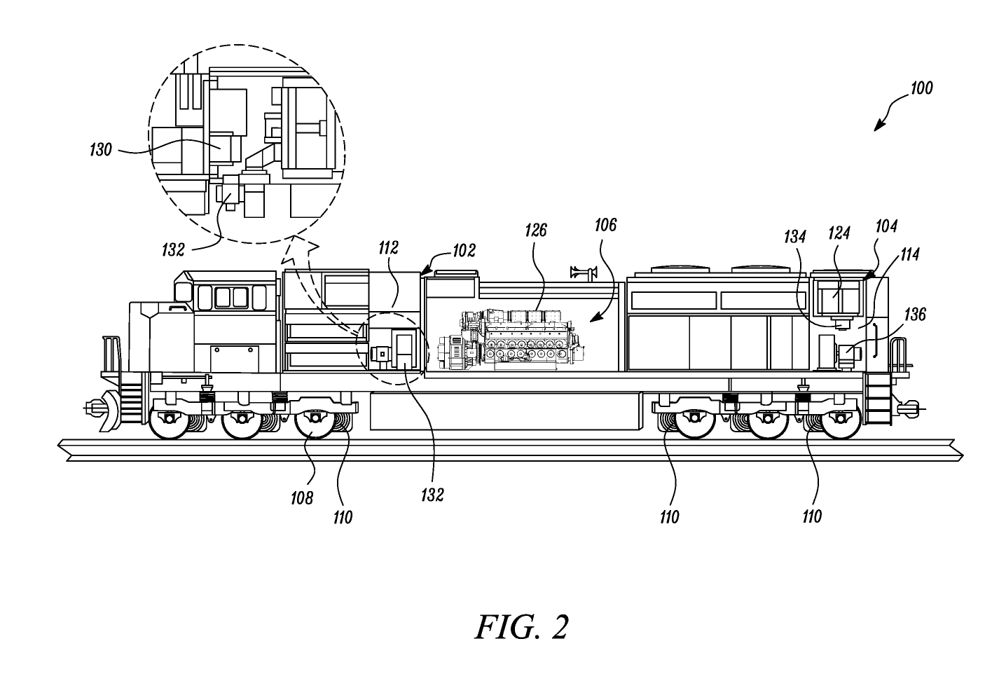

FIG. 1 illustrates an exemplary machine 100. In an embodiment, the machine 100 is a locomotive. Therefore, the machine 100 may be interchangeably referred as the locomotive 100. The locomotive 100 may include a dual-fueled electric locomotive. The locomotive 100 may include single locomotive, multiple locomotives, a train moved by single locomotive, a train moved by multiple locomotives and any other arrangement of locomotives. As shown in FIG. 1, the locomotive 100 may include a first compartment 102, a second compartment 104, a power compartment 106, at least one wheel 108, at least one traction motor 110, a front air inlet 112, a rear air inlet 114 and at least one electrical component 116. The at least one wheel 108 may include plurality of wheels. The at least one traction motor 110 may include plurality of traction motors. The traction motor 110 may drive the wheel 108. The at least one electrical component 116 may include plurality of electrical components. The electrical component 116 may be any component associated with an electric traction system (not shown) of the locomotive 100 and generating heat. In an embodiment, the electrical component 116 may include the traction motor 110, a generator (not shown), a dynamic brake grid 124 (shown in FIG. 2), an electrical locker (not shown) or other such components. As shown in FIG. 1, at least one container 118 that is used to store liquefied natural gas (hereinafter referred as LNG) may be provided. The container 118 may be on-board and/or off-board the locomotive 100. In an embodiment, the container 118 is off-board the locomotive 100 and shown as a tender coupled to the locomotive 100. A pump 120 is shown to be mounted on the container 118 and is configured to pump and supply the LNG from the container 118 to the locomotive 100 via a supply line 122.

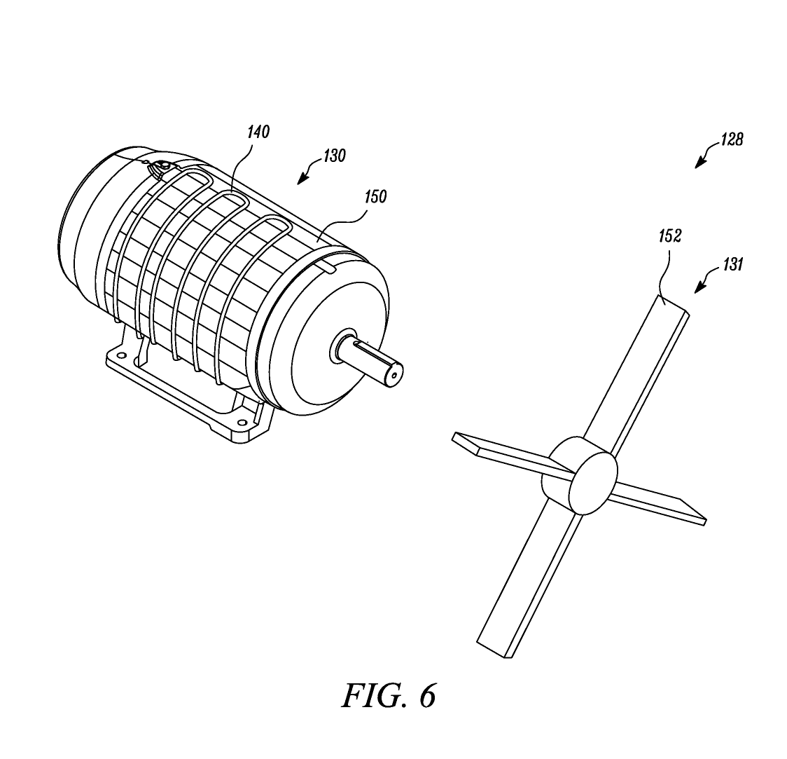

In an embodiment, FIG. 2 shows an enlarged view of the locomotive 100. More specifically, it shows an enlarged top view of the first compartment 102 and, a side view of the second compartment 104 and the power compartment 106. The second compartment 104 may include the dynamic brake grid 124. The dynamic brake grid 124 may include a plurality of resistors for converting electrical power generated during dynamic braking into heat. The power compartment 106 may include at least one engine 126. The at least one engine 126 may include a plurality of engines. The engine 126 may be a dual-fueled engine. In an embodiment, the engine 126 is fueled with the LNG. The first compartment 102 and the second compartment 104 may include at least one blower 128 (shown in FIG. 6). The at least one blower 128 may include plurality of blowers. In an embodiment, the blower 128 may include a first traction blower 130, a generator blower 132, a dynamic brake grid blower 134, a second traction blower 136, an electrical locker blower (not shown) and a radiator blower (not shown).

As shown in FIG. 2, the first traction blower 130 and the second traction blower 136 may direct an air flow towards the traction motor 110 for cooling. The generator blower 132 may direct an air flow towards the generator (not shown) for cooling, the generator being driven by the engine 126. The dynamic brake grid blower 134 may direct an air flow towards the dynamic brake grid 124 for cooling. The electrical locker blower (not shown) may direct an air flow towards the electrical locker (not shown) for cooling. The radiator blower (not shown) may direct an air flow towards a radiator (not shown) for cooling. As shown in FIG. 2, the first traction blower 130 and the generator blower 132 may be placed in the first compartment 102 (shown in the enlarged view). The dynamic brake grid 124, the dynamic brake grid blower 134 and the second traction blower 136 may be placed in the second compartment 104.

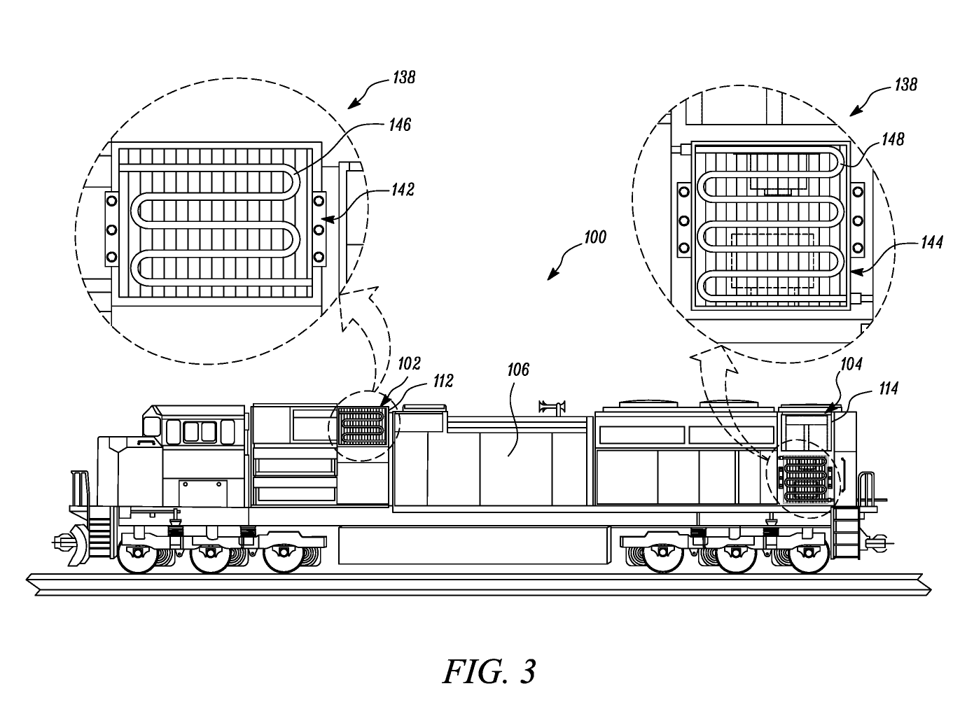

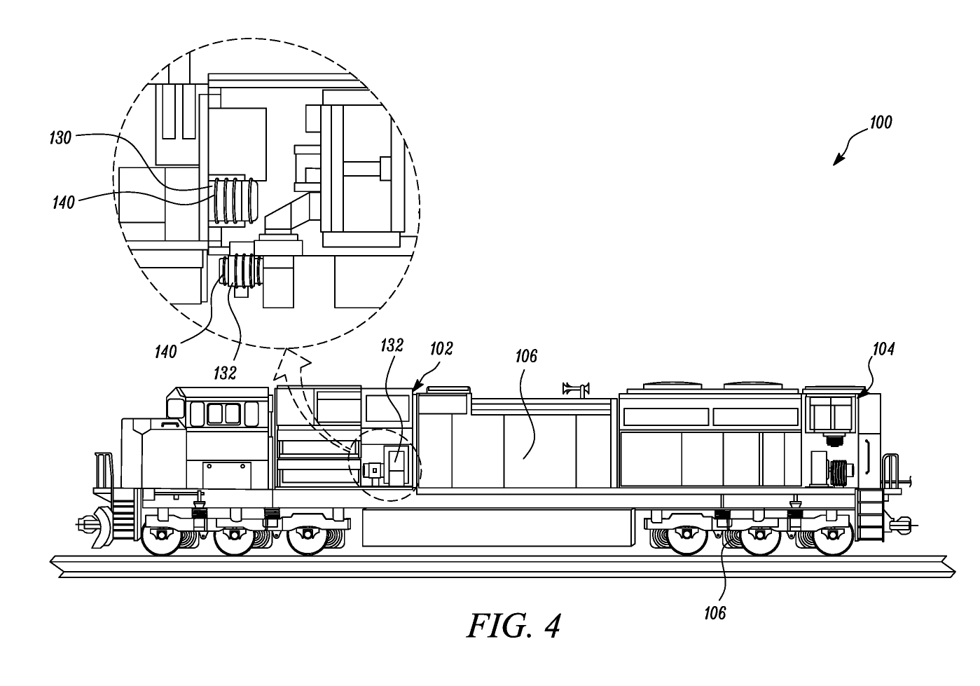

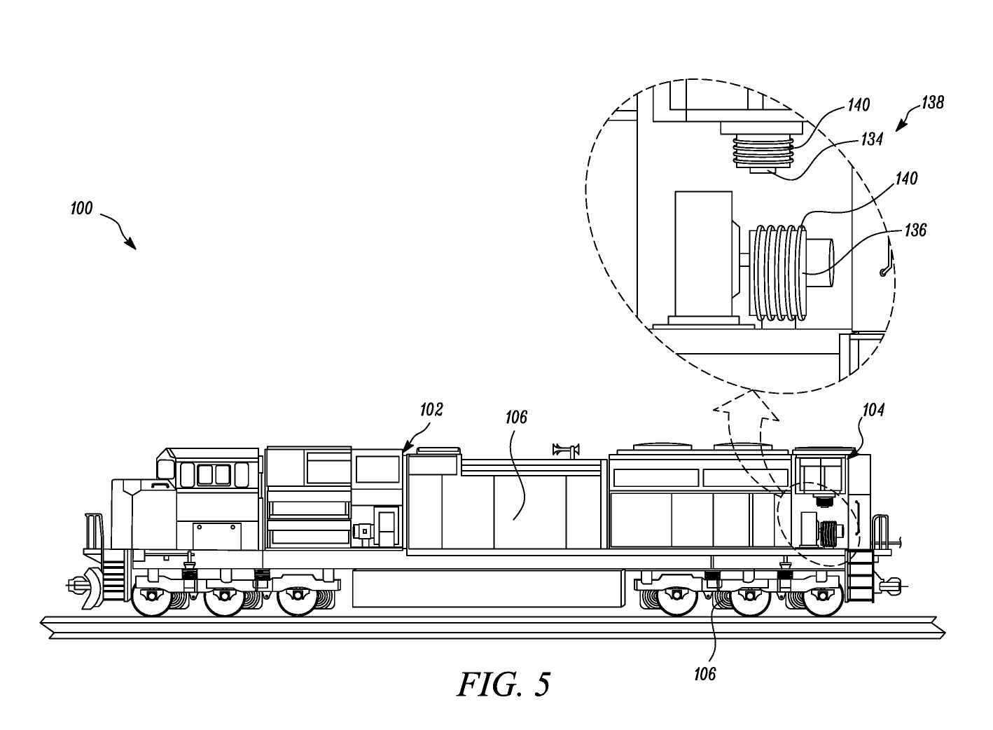

FIG. 3 illustrates a cooling system 138 in another embodiment. The cooling system 138 may include a heat exchanger 140 (shown in FIG. 4, FIG. 5 and FIG. 6). In an embodiment, the heat exchanger 140 may include a first heat exchanger 142 and a second heat exchanger 144. Although, only two heat exchangers are shown in this embodiment, it is also contemplated that more than two heat exchangers may be used and this is well within the ambit of the working of the present disclosure. The first heat exchanger 142 may be placed in the front air inlet 112, and the second heat exchanger 144 may be placed in the rear air inlet 114. The front air inlet 112 may be positioned in the first compartment 102 and the second air inlet 114 may be positioned in the second compartment 104. The first heat exchanger 142 may include a first tube 146 for facilitating flow of a coolant. The second heat exchanger 144 may include a second tube 148 for facilitating flow of the coolant. The coolant may include the LNG being provided by the pump 120 (shown in FIG. 1). The first tube 146 and the second tube 148 may be made of a thermally conductive material such as copper or any other material used for making tubes for heat exchanging.

FIG. 4 illustrates an enlarged view of the cooling system 138. More specifically, FIG. 4 shows an enlarged top view of the first compartment 102 of the locomotive 100 (shown in FIG. 1). In an embodiment, the heat exchanger 140 of the cooling system 138 may be incorporated in at least one of the blower 128 (shown in FIG. 6). By incorporating the heat exchanger 140, the heat exchanger 140 can be configured to be wrapped around the blower 128. As shown in FIG. 4, the first traction blower 130 and the generator blower 132 of the first compartment 102 have the heat exchanger 140 wrapped around them.

FIG. 5 illustrates an enlarged view of the cooling system 138. More specifically, FIG. 5 shows an enlarged view of the second compartment 104 of the locomotive 100 (shown in FIG. 1). In an embodiment, the heat exchanger 140 of the cooling system 138 may be incorporated in at least one of the blower 128 (shown in FIG. 6). By incorporating the heat exchanger 140, the heat exchanger 140 can be configured to be wrapped around the blower 128. As shown in FIG. 5, the first traction blower 130 and the generator blower 132 of the first compartment 102 and the second traction blower 134 and the dynamic brake grid blower 132 have the heat exchanger 140 wrapped around them.

FIG. 6 illustrates an exploded view of the blower 128. The blower 128 may include a motor 129 and a fan 131, the fan having a blade 152. As shown, the heat exchanger 140 may be wrapped around the motor 129. More specifically, the heat exchanger 140 can be incorporated in a stator frame 150 of the motor 129. The stator frame 150 may be made of copper or iron or any other such material. The LNG is configured to flow through the heat exchanger 140 of the motor 129. It may be noted that the wrapping of the heat exchanger 138 around the motor 129 may be carried in any manner and in any direction. For exemplary purposes, the wrapping may be done in a longitudinal or lateral direction or in a circular or zig-zag manner.

### INDUSTRIAL APPLICABILITY

The present disclosure discloses the cooling system 138 for the electrical component 116 of the locomotive 100. The disclosure provides for the cooling system 116 to be constituted of the blower 128 and the heat exchanger 140. The air flow from the blower 128 is directed towards the electrical component 116 and the air flow is cooled by the LNG being passed through the heat exchanger 140. The heat exchanger 140 is arranged upstream of the electrical component 116, thereby the electrical component 116 is cooled using the LNG.

In an aspect of the present disclosure, the cooling system 138 is placed in the front air inlet 112 and the rear air inlet 114. Referring to FIG. 3, the first heat exchanger 142 is placed in the front air inlet 112 of the first compartment 102. The second heat exchanger 144 is placed in the rear air inlet 114 of the second compartment 104. This placement of the heat exchanger 140 provides for cooling of the air flow by the LNG. This air flow is being directed inside the first compartment 102 and the second compartment 104 by the blower 128 for cooling the electrical component 116 placed inside the two compartments. Referring to FIG. 3, the heat exchanger 140 is arranged upstream of the electrical component 116. Also, the blower 128 may be positioned either upstream or downstream of the heat exchanger 140. Further, when the blower 128 is positioned downstream of the heat exchanger 140, it may be positioned either upstream or downstream of the electrical component 116. Irrespective of the positioning, the LNG being flowed via the heat exchanger 140 will cool the air flow being and thereby the electrical component 116. The cooling system 138 provides for retrofitting of the current locomotives as it may be fitted in any air inlet provided for any electrical component venting. Furthermore, the use of the LNG serves the dual purpose of effectively cooling the electrical component 116 and heating the LNG, thereby increasing the efficiency of the cooling system 138. This further enhances the overall efficiency while avoiding complex construction.

In yet another aspect of the present disclosure, the cooling system 138 for the electrical component 116 is placed in the blower 128 itself. This is done by incorporating the heat exchanger 140 of the cooling system 138 in the blower 128, as illustrated in FIG. 4, FIG. 5 and FIG. 6. The heat exchanger 140 may be incorporated in the motor 129 of the blower 128 according the proportion of heat generated and/or cooling required. Further, the heat exchanger 140 may be incorporated in the stator frame 150 of the motor 129. In the present embodiment, the blower 128 is always positioned upstream of the electrical component 116 for cooling. This is done to cool the air flow being directed towards the electrical component 116 by the LNG passing through the heat exchanger 140 incorporated in the blower 128. The incorporation of the heat exchanger 140 in the blower 128 eliminates the cost of using any external heat exchanger. It also provides the chance of retrofitting of any existing locomotive by either replacing their blower or only the stator frame of their blower. The LNG passing through the heat exchanger 140 is heated in the process thereby reducing cost for an extra heating component.

What is claimed is:

1. A system for cooling at least one electrical component of a machine, the machine powered by liquefied natural gas (LNG), the system comprising:
at least one blower arranged to direct an air flow towards the at least one electrical component; and
at least one heat exchanger arranged upstream of the at least one electrical component, the at least one heat exchanger using the LNG as coolant for cooling the air flow being directed towards the at least one electrical component.

2. The system of claim 1, wherein the at least one blower is positioned at least one of upstream of the at least one heat exchanger, and downstream of the at least one heat exchanger.

3. The system of claim 2, wherein the at least one blower is positioned downstream of the at least one heat exchanger, and at least one of upstream of the at least one electrical component, and downstream of the at least one electrical component.

4. The system of claim 1, wherein the at least one heat exchanger is incorporated in the at least one blower.

5. The system of claim 4, wherein the at least one blower has a motor and a fan, and the at least one heat exchanger is incorporated in the motor.

6. The system of claim 5, wherein the motor has a stator frame and a rotor, and the at least one heat exchanger is incorporated in the stator frame.

7. A machine comprising:
at least one engine powered by liquefied natural gas (LNG);
at least one electrical component;
at least one blower arranged to direct an air flow towards the at least one electrical component; and
at least one heat exchanger arranged upstream of the at least one electrical component, the at least one heat exchanger using the LNG as coolant for cooling the air flow being directed towards the at least one electrical component.

8. The machine of claim 7, wherein the at least one blower is positioned at least one of upstream of the at least one heat exchanger, and downstream of the at least one heat exchanger.

9. The machine of claim 8, wherein the at least one blower is positioned downstream of the at least one heat exchanger, and at least one of upstream of the at least one electrical component and downstream of the at least one electrical component.

10. The machine of claim 7, wherein the at least one heat exchanger is incorporated in the at least one blower.

11. The machine of claim 10, wherein the at least one blower has a motor and a fan, and the at least one heat exchanger is incorporated in the motor.

12. The machine of claim 11, wherein the motor has a stator frame and a rotor, and the at least one heat exchanger is incorporated in the stator frame.

13. A locomotive comprising:
at least one engine powered by liquefied natural gas (LNG);
at least one container to store the LNG and configured to supply the LNG to the at least one engine;
at least one electrical component associated with an electric traction system of the locomotive;
at least one blower arranged to direct an air flow towards the at least one electrical component; and
at least one heat exchanger arranged upstream of the at least one electrical component and in fluid communication with the at least one container, the at least one heat exchanger using the LNG as coolant for cooling the air flow being directed towards the at least one electrical component.

14. The locomotive of claim 13, wherein the at least one container is at least one of on-board, and off-board the locomotive.

15. The locomotive of claim 13, wherein the at least one electrical component is a dynamic brake grid.

16. The locomotive of claim 13, wherein the at least one blower is positioned at least one of upstream of the at least one heat exchanger, and downstream of the at least one heat exchanger.

17. The locomotive of claim 16, wherein the at least one blower is positioned downstream of the at least one heat exchanger, and at least one of the upstream of the at least one electrical component and downstream of the at least one electrical component.

18. The locomotive of claim 13, wherein the at least one heat exchanger is incorporated in the at least one blower.

19. The locomotive of claim 18, wherein the blower has a motor and a fan, and the at least one heat exchanger is incorporated in the motor.

20. The locomotive of claim 19, wherein the motor has a stator frame and a rotor, and the at least one heat exchanger is incorporated in the stator frame.
